(19) United States
(12) Patent Application Publication
(10) Pub. No.: US 2008/0139036 A1
(43) Pub. Date: Jun. 12, 2008

(54) Electrical connector assembly with plated conductive surfaces

(75) Inventors: Philip Clay Brandberg, Carlisle, PA (US); Peter P. Wilson, Palmyra, PA (US); Donald Everett Wood, Hummelstown, PA (US)

Correspondence Address: Robert J. Kapalka;Tyco Electronics Corporation, 4550 New Linden Hill Road, Suite 140, Wilmington, DE, 19808-2952, US

(73) Assignee: Tyco Electronics Corporation

(21) Appl. No.: 11/635,260

(22) Filed: Dec. 7, 2006

(51) Int. Cl. H01R 13/62

(52) U.S. Cl. 439/359

(57) ABSTRACT

An electrical connector includes a dielectric housing having a housing base configured to be mounted on a substrate and an upper housing configured to be joined to the housing base. The housing base and the upper housing cooperate to define a contact cavity. The housing base includes plated conductive surfaces that provide a conductive path from the contact cavity to an electrical path on the substrate. A contact is held in the contact cavity. The contact is configured to mate with a contact in a mating connector.

### BACKGROUND OF THE INVENTION

The invention relates generally to electrical connectors, and more particularly, to a first mate grounding connector for interconnecting circuit boards.

Some electronic systems, such as some networks and computer systems, include a main or primary circuit board, such as a backplane board or mother board, connected to one or more peripheral circuit boards called daughter cards. Electrical connectors establish electrical communication between the main board and the daughter cards. In order to reduce the possibility of damage to the electrical components on the main board and the daughter card, a grounding connector is provided to establish a ground connection between the circuit boards. This grounding connector is typically the first connector to mate when the circuit boards are connected. In this manner, a ground path is provided for discharging any static electricity or unwanted currents that may be present that may damage components on the circuit boards. In addition to establishing a ground connection, the connector may also provide some amount of mechanical guidance that allows at least gross alignment of the daughter card to the main board.

Typically, the ground connector is a one piece die cast metal connector that can be costly to produce due to the expense of the die casting processes. Furthermore, the die cast connector is susceptible to corrosion which may degrade the quality or reliability of the electrical connection between the connector and the circuit board on which the ground connector is mounted.

It would be desirable to provide a grounding connector that can be more economically produced while providing a more reliable electrical connection between the grounding connector and a circuit board.

### BRIEF DESCRIPTION OF THE INVENTION

In one aspect, an electrical connector is provided. The connector includes a dielectric housing having a housing base configured to be mounted on a substrate and an upper housing configured to be joined to the housing base. The housing base and the upper housing cooperate to define a contact cavity. The housing base includes plated conductive surfaces that provide a conductive path from the contact cavity to an electrical path on the substrate. A contact is held in the contact cavity. The contact is configured to mate with a contact in a mating connector.

Further, the housing base includes a threaded insert to mechanically mount the connector on the substrate. The housing base includes a locking element that engages a ledge on the upper housing to retain the upper housing on the housing base. The contact cavity includes a step that engages an edge of the contact to position the contact in the contact cavity. The upper housing includes a keying slot and the housing base includes a keying element that is received in the keying slot to position the upper housing on the housing base.

In another aspect, an electrical connector is provided that includes a dielectric housing having a housing base configured to be mounted on a substrate and an upper housing configured to be joined to the housing base. The housing base and the upper housing cooperate to define a contact cavity. The housing base includes plated conductive surfaces that provide a conductive path from the contact cavity to an electrical path on the substrate. A contact is held in the contact cavity. The contact electrically engages one of the plated surfaces of the housing base to electrically connect the contact to the electrical path on the substrate.

In yet another embodiment, an electrical connector is provided that includes a dielectric housing having a housing base configured to be mounted on a substrate and an upper housing configured to be joined to the housing base. The housing base and the upper housing cooperate to define a contact cavity. The housing base includes plated conductive surfaces that provide a conductive path from the contact cavity to an electrical path on the substrate. The upper housing includes an interior wall and a step proximate a rearward end that establish a length of the contact cavity. A contact is held in the contact cavity. The contact electrically engages one of the plated surfaces of the housing base to electrically connect the contact to the electrical path on the substrate.

### BRIEF DESCRIPTION OF THE DRAWINGS

FIG. 1 is a perspective view of an electrical connector formed in accordance with an exemplary embodiment of the present invention.

FIG. 2 is an exploded view of the connector shown in FIG. 1.

FIG. 3 is a cross-sectional view of the housing base taken along the line 3-3 shown in FIG. 2.

FIG. 4 is a bottom perspective view of the housing base shown in FIG. 2.

FIG. 5 is a cross-sectional view of the upper housing taken along the line 5-5 shown in FIG. 2.

FIG. 6 is a bottom perspective view of the upper housing shown in FIG. 2.

### DETAILED DESCRIPTION OF THE INVENTION

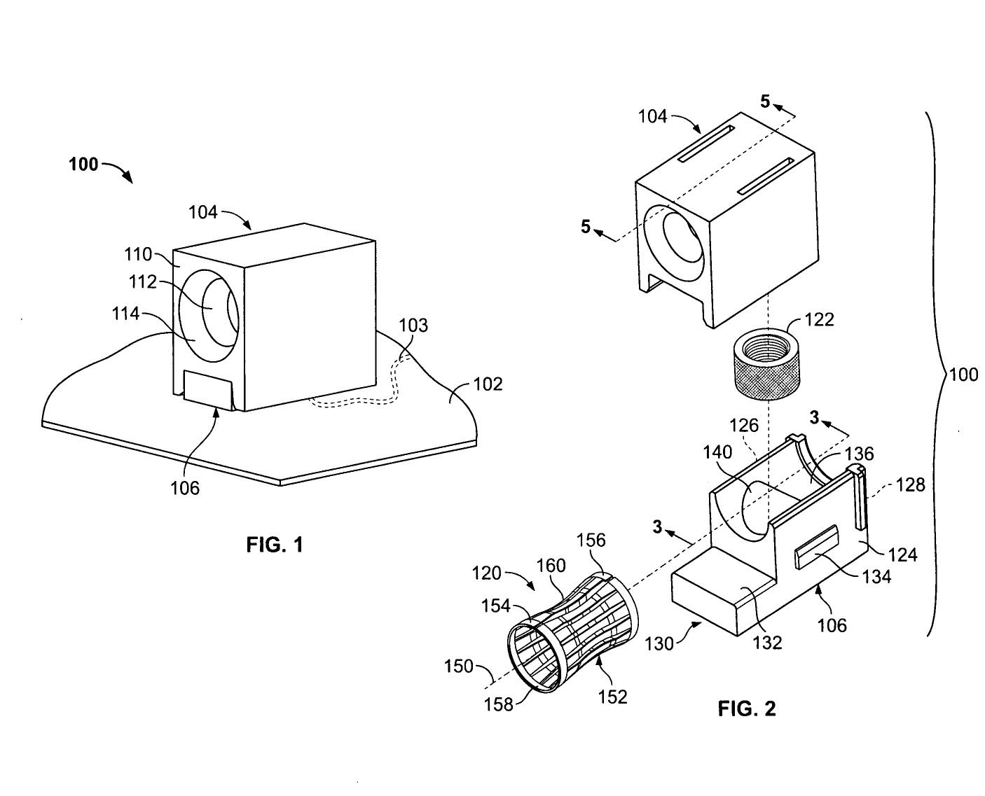

FIG. 1 is a perspective view of an electrical connector 100 formed in accordance with an exemplary embodiment of the present invention. The connector 100 is mounted on a substrate 102, such as a circuit board. The connector 100 is configured to mate with another connector (not shown) on a secondary substrate (not shown) to interconnect the secondary substrate to the substrate 102. When mounted on the substrate 102, the connector 100 is electrically connected to an electrical path 103. In the exemplary embodiment the connector 100 is a grounding connector, the electrical path is a ground trace, and the substrate 102 is a circuit board. However, it should be understood that while the invention will be described in terms of a grounding connector such as the connector 100, the following description is for illustrative purposes only and is but one potential application of the inventive concepts herein. For example, it should be appreciated that the benefits and advantages of the invention may accrue equally to other types of connectors, such as power and various signal connectors, and that these connectors may be mounted on various forms of the substrate 102 such as a backplane, a motherboard, or other circuit board, a bus bar, or a chassis of an electrical assembly. Further, the secondary substrate may be a daughter card or other circuit boards, or some other electrical device. None of these examples is intended to be limiting.

The connector 100 includes an upper housing 104 that is joined to a housing base 106. Upper housing 104 includes a mating end 110 having a contact aperture 112 that is configured to receive a contact (not shown) from a mating connector. A conical recess 114 is formed at the opening of the aperture 112. The conical recess 114 receives the mating contact and assists in centering the mating contact in the contact aperture 112. When the connector 100 is mated with the mating connector, an electrical connection, or more specifically, a ground connection is established between the substrate 102 and the secondary substrate or daughter card. Further, the connector 100 is a first mate connector, that is when the substrate 102 is connected with the daughter card, the connector 100 mates with the mating connector to establish a ground connection before any other connections are made between the substrate 102 and the daughter card.

FIG. 2 illustrates an exploded view of the connector 100. The connector 100 includes the upper housing 104, the housing base 106, a contact 120, and a threaded insert 122. The housing base 106 is fabricated from a dielectric material that is plated with a conductive material. In an exemplary embodiment, the housing base 106 is plated over its entirety with a precious metal for improved electrical conductivity and the plating extends over the entire surface of the housing base 106. The housing base 106 has opposed planar side walls 124 and 126, a rearward end 128, and a forward end 130 that is formed with a step 132. Each side wall 124, 126 includes a locking element 134. The housing base 106 includes a plated upper surface 136 that has a contour that is complementary to a shape of the contact 120.

The housing base 106 includes an interior hole 140 that receives the threaded insert 122. In one embodiment, threaded insert 122 is press fit into the housing base 106. The threaded insert 122 is fabricated from a conductive metallic material and receives a fastener (not shown) from the underside of the substrate 102 to mechanically mount the connector 100 on the substrate 102 (FIG. 1).

The contact 120 in the illustrated embodiment is a crown contact having a longitudinal axis 150 and a plurality of longitudinally extending members 152 that are joined at opposed ends by rims 154 and 156. Each rim 154, 156 includes an outward facing edge 158, only one of which is visible in FIG. 2. The longitudinally extending members have central portions 160 that bend inward to grip a mating pin contact (not shown). In alternative embodiments, the contact 120 may have other configurations to receive different contact shapes. The contact 120 rests on and electrically engages the upper surface 136 of the housing base 106 so that a conductive path is established between the contact 120 and an electrical path on the substrate 102 when the connector 100 is mounted on the substrate 102 (FIG. 1).

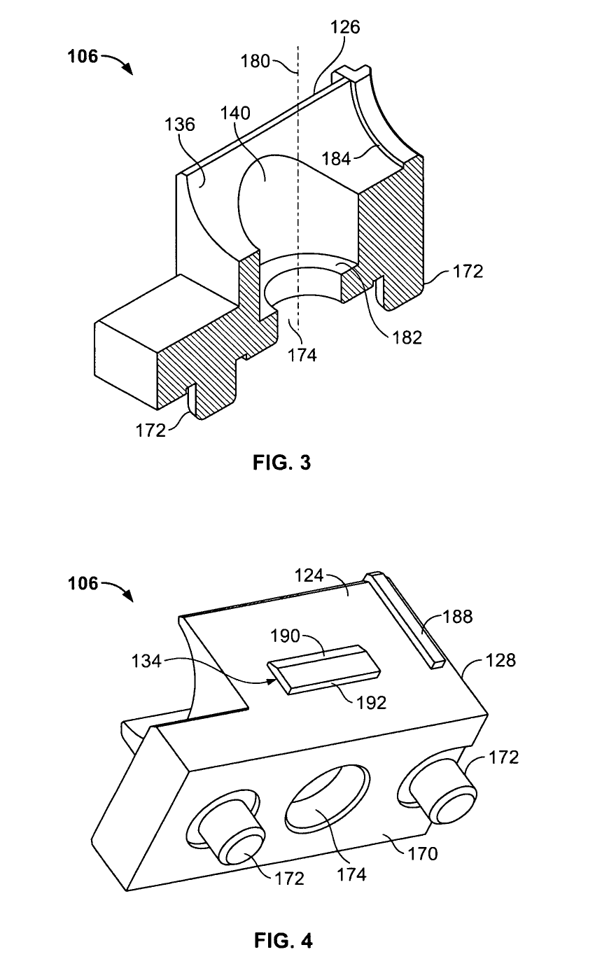

FIG. 3 illustrates a cross-sectional view of the housing base 106. FIG. 4 illustrates a bottom perspective view of the housing base 106. The housing base 106 includes a mounting surface 170 that electrically engages an electrical path such as a ground path on the substrate 102 (FIG. 1). Locating pegs 172 extend from the mounting surface 170 and are provided to locate the connector 100 (FIG. 1) on the substrate 102. A mounting hole 174 extends through the mounting surface 170. The interior hole 140 and the mounting hole 174 have a common centerline 180. The interior hole 140 has a diameter greater than the diameter of the mounting hole 174 such that a counterbored seat 182 is provided that establishes a seating depth for the threaded insert 122 in the interior hole 140. Mounting hole 174 receives the threaded fastener that is threaded into the threaded insert 122 to mount the connector 100 to the substrate 102.

The upper surface 136 is formed with a step 184 that engages an outward facing edge 158 on the contact 120 (FIG. 2). A keying element 188 is formed on each side wall 124, 126 proximate the rearward end 128 of the lower housing 106. The locking element 134 includes a beveled upper edge 190 and a downward facing locking edge 192.

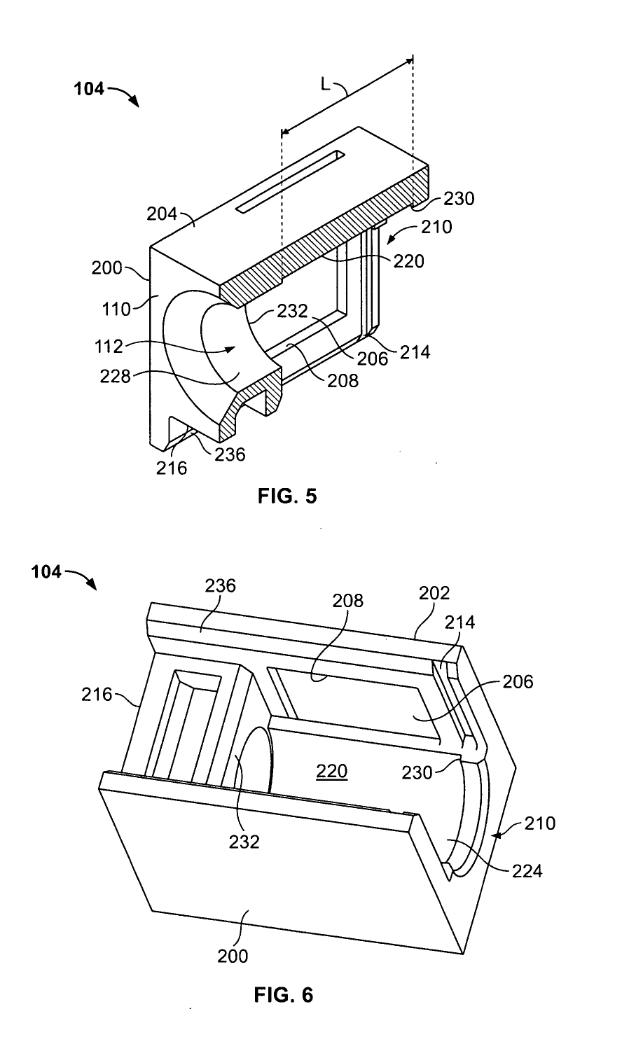

FIG. 5 is a cross-sectional view of the upper housing 104. FIG. 6 is a bottom perspective view of the upper housing 104. The upper housing 104 includes opposed side walls 200 and 202 and a top wall 204. A recess 206 is formed on an interior side of each side wall 200, 202. The recess defines a ledge 208 that engages the locking edge 192 of the locking element 134 (FIG. 4) to retain the upper housing 104 on the housing base 106 when the upper housing 104 is joined to the housing base 106. Once joined, the upper housing 104 and the housing base 106 are not intended to be separated. The upper housing 104 has a rearward end 210 opposite the mating end 110. A keying slot 214 is formed in the interior of each side wall 200, 202 proximate the rearward end 210. The keying elements 188 on the housing base 106 are received in the keying slots 214 to position the upper housing 104 on the housing base 106. A cutout 216 at the mating end 110 of the upper housing receives the step 132 in the housing base 106 when the upper housing 104 and the housing base 106 are joined.

An underside of the top wall 204 has an interior surface 220 that has a contour that is complementary to a shape of the contact 120. In an exemplary embodiment, the interior surface 220 of the upper housing and the upper surface 136 of the housing base 106 (FIG. 3) have a substantially circular curvature. When the upper housing 104 and the housing base 106 are joined, the interior surface 220 of the upper housing 104 and the upper surface 136 of the housing base 106 cooperate to form a contact cavity 224, half of which is shown in FIG. 6. The contact cavity 224 is sized to receive the contact 120. The interior surface 220 includes a rearward step 230 proximate the rearward end 210 that together with the step 184 on the upper surface 136 of the housing base 106 engage the outward facing edge 158 on the contact 120 (FIG. 2) to position the contact 120 in the contact cavity 224. The contact aperture 112 is bounded by a circumferential wall 228 that ends at a rearward facing interior wall 232. The interior wall 232 and the rearward step 230 define a length L of the contact cavity 224. The interior wall 232 may engage the outward facing edge 158 of a forward end of the contact 120 to assist in positioning the contact 120 in the contact cavity 224.

The connector 100 is assembled by first inserting the threaded insert 122 into the interior hole 140. The contact 120 is then positioned on the upper surface 136 of the housing base 106. Finally, the upper housing 104 is placed over the housing base 106 and is forced downward onto the housing base 106 to join the upper housing 104 to the housing base 106. The side walls 200 and 202 include beveled edges 236 for ease in pushing the upper housing 104 over the housing base 106. As the housing base 106 is fully received in the upper housing 104, the locking element 134 snaps into the recess 206 to lock the upper housing 204 and the housing base 106 together.

The embodiments thus described provide an electrical connector for use in interconnecting substrates that can be economically manufactured. As opposed to one-piece die cast housings of the prior art, the connector includes a molded two-piece dielectric housing. The housing base is plated with a precious metal that provides an improved electrical connection between the housing base and an electrical path on the substrate on which it is mounted.

While the invention has been described in terms of various specific embodiments, those skilled in the art will recognize that the invention can be practiced with modification within the spirit and scope of the claims.

1. An electrical connector comprising:
a dielectric housing including a housing base configured to be mounted on a substrate and an upper housing configured to be joined to said housing base, said upper housing including a forward mating end and an opposite rearward end, said housing base and said upper housing cooperating to define a contact cavity between a rearward facing interior wall proximate said forward mating end and said rearward end, and said housing base including plated conductive surfaces that provide a conductive path from said contact cavity to an electrical path on the substrate; and
a contact held in said contact cavity, said contact configured to mate with a contact in a mating connector.

2. The electrical connector of claim 1, wherein said housing base includes a threaded insert to mechanically mount the connector on the substrate.

3. The electrical connector of claim 1, wherein said housing base includes a locking element that engages a ledge on said upper housing to retain said upper housing on said housing base.

4. The electrical connector of claim 1, wherein said mating end defines an aperture to receive a contact of a mating connector.

5. The electrical connector of claim 1, wherein said contact cavity includes a step that engages an edge of said contact to position said contact in said contact cavity.

6. The electrical connector of claim 1, wherein said upper housing includes a keying slot and said housing base includes a keying element that is received in said keying slot to position said upper housing on said housing base.

7. The electrical connector of claim 1, wherein said housing base includes a mounting surface having a peg extending therefrom, said peg being received in a bole in the substrate to locate the connector on the substrate.

8. An electrical connector comprising:
a dielectric housing including a housing base configured to be mounted on a substrate and an upper housing configured to be joined to said housing base, said upper housing including a forward mating end and an opposite rearward end, said housing base and said upper housing cooperating to define a contact cavity between a rearward facing interior wall proximate said forward mating end and said rearward end, and said housing base including plated conductive surfaces that provide a conductive path from said contact cavity to an electrical path on the substrate; and
a contact held in said contact cavity, said contact electrically engaging one of said plated surfaces of said housing base to electrically connect said contact to the electrical path on the substrate.

9. The electrical connector of claim 8, wherein said housing base includes a threaded insert to mechanically mount the connector on the substrate.

10. The electrical connector of claim 8, wherein said housing base includes a locking element that engages a ledge on said upper housing to retain said upper housing on said housing base.

11. The electrical connector of claim 8, wherein said mating end defines an aperture to receive a contact of a mating connector.

12. The electrical connector of claim 8, wherein said contact cavity includes a step that engages an edge of said contact to position said contact in said contact cavity.

13. The electrical connector of claim 8, wherein said upper housing includes a keying slot and said housing base includes a keying element that is received in said keying slot to position said upper housing on said housing base.

14. The electrical connector of claim 8, wherein said housing base includes a mounting surface having a peg extending therefrom, said peg being received in a hole in the substrate to locate the connector on the substrate.

15. An electrical connector comprising:
a dielectric housing including a housing base configured to be mounted on a substrate and an upper housing configured to be joined to said housing base, said upper housing including a forward mating end and an opposite rearward end, said housing base and said upper housing cooperating to define a contact cavity and said housing base including plated conductive surfaces that provide a conductive path from said contact cavity to an electrical path on the substrate, and wherein said upper housing includes a rearward facing interior wall proximate said mating end and a step proximate a said rearward end that establish a length of said contact cavity; and
a contact held in said contact cavity, said contact electrically engaging one of said plated surfaces of said housing base to electrically connect said contact to the electrical path on the substrate.

16. The electrical connector of claim 15, wherein said housing base includes a forward end formed with a step and said upper housing includes a cutout configured to receive said step.

17. The electrical connector of claim 15, wherein said housing base includes a locking element that engages a ledge on said upper housing to retain said upper housing on said housing base.

18. The electrical connector of claim 15, wherein said mating end defines an aperture to receive a contact of a mating connector.

19. The electrical connector of claim 15, wherein said contact cavity includes a step that engages an edge of said contact to position said contact in said contact cavity.

20. The electrical connector of claim 15, wherein said upper housing includes a keying slot and said housing base includes a keying element that is received in said keying slot to position said upper housing on said housing base.
